(19) United States
(12) Patent Application Publication
(10) Pub. No.: US 2018/0124716 A1
(43) Pub. Date: May 3, 2018

(54) SYSTEMS AND METHODS PROVIDING ADAPTIVE POWER TRACKING

(71) Applicant: QUALCOMM Incorporated, San Diego, CA (US)

(72) Inventors: Sudarsan Krishnan, San Diego, CA (US); Andrei Izotov, Del Mar, CA (US); Carl Hardin, Encinitas, CA (US); Vijay Chellappa, Seattle, WA (US); Li Gao, San Diego, CA (US)

(21) Appl. No.: 15/472,943

(22) Filed: Mar. 29, 2017

Related U.S. Application Data
(60) Provisional application No. 62/416,769, filed on Nov. 3, 2016.

(51) Int. Cl. H04W 52/52

(52) U.S. Cl. CPC H04W 52/52; H04L 49/109

(57) ABSTRACT

A radio frequency (RF) system including: a modem configured to generate a first set of digital bits and to create an analog RF signal from those digital bits; a power amplifier configured to receive the analog RF signal and to amplify the analog RF signal, the power amplifier including an input for a biasing voltage; a feedback loop configured to sample an output of the power amplifier, generate a second set of digital bits corresponding to the first set of digital bits, digitally process the second set of digital bits to determine a linearity characteristic of the power amplifier, and to adjust the biasing voltage in response to determining the linearity characteristic.

### CROSS-REFERENCE TO RELATED APPLICATIONS

The present application claims the benefit of U.S. Provisional Patent Application No. 62/416,769, filed Nov. 3, 2016, and entitled “SYSTEMS AND METHODS PROVIDING ADAPTIVE POWER TRACKING,” the disclosure of which is incorporated by reference herein in its entirety.

### TECHNICAL FIELD

This application relates to power amplifiers, and more particularly, to adaptive power tracking in power amplifiers.

### BACKGROUND

Some conventional systems use radio frequency (RF) power amplifiers (PAs) with average power tracking (APT). As background to average power tracking, there is a trade-off between efficiency and linearity in the use of PAs generally. An example of efficiency includes total output power from the PA divided by input power to the PA. An example of a measure of linearity includes adjacent channel leakage ratio (ACLR), which is a measure of noise energy inserted into adjacent channels by the PA.

In general, as output power goes up, an APT system increases the PA bias to maintain linearity, and as output power goes down, the system decreases the PA bias to reduce power usage while still remaining within linearity parameters. Or put another way, at a first output power, the system may use a first value for PA bias. But if output power goes down, keeping the bias at the first value may be expected to provide a high degree of linearity but may waste power. Accordingly, APT may move the value of PA bias down, reducing the degree of linearity while maintaining linearity within acceptable limits. This balances efficiency and linearity.

An example of adjusting PA bias includes increasing or decreasing a power supply voltage to the amplifier. Thus, these conventional APT systems may adjust power supply voltage to the amplifier during normal operation to track output power.

Furthermore, some systems use an open loop form of APT, where a device including APT functionality stores a table of power supply values and output power values. As the device operates, it receives commands to operate at a particular value for output power. APT functionality in the device accesses the table to read a value for power supply voltage that is associated with the output power, and APT functionality applies that power supply voltage to the system. Open loop works well in many scenarios, but it may not be able to adjust for phenomena such as temperature variation, so engineers generally build in a safety margin to the power supply voltage values in the table to ensure that the PA operates within acceptable levels of ACLR. However, margin necessarily means that some amount of power will be wasted.

Furthermore, it may be quite labor-intensive to build open loop operating tables. In a conventional system having a modem chip that applies gain and a PA that receives the signal from the modem chip and further applies gain, much engineering expenditure may go into building open loop operating tables to account for behavior the modem chip and the PA at various output power levels. In one example, one part of the labor may include sweeping gain values at the modem chip and measuring output power values at the antenna while holding a bias of the PA constant, and then building a table that correlates output power and modem chip gain. However, biasing the PA may affect the gain at the PA somewhat, so that the table that was built may not be entirely accurate for a system that assumes that PA bias may change. Accordingly, after manufacture of a board that includes the modem chip and the PA, engineers may use external test equipment to determine a relationship between output power and PA bias by adjusting PA bias at a particular modem chip gain and observing the effects on output power and on ACLR. The engineers may do this for a variety of different power levels, eventually producing a table that correlates modem chip gain, PA bias, and output power level. The PA bias values in the table may include ACLR margin large enough to ensure that under expected operating conditions ACLR will not exceed specified levels. As noted above, this margin necessarily results in bias values that may waste power at the PA.

Recent advances include modem chips that are capable of digitally measuring antenna output RF metric such as ACLR during normal use of a device based on feedback coupling from the transmit path. It would be desirable to use available modem resources to reduce the amount of margin in a PA system and to reduce or eliminate effort in building open loop operating tables.

### SUMMARY

Various embodiments described herein provide digital systems and methods to adaptively adjust a power amplifier bias in a transmitter system. In one example, the transmitter system feeds back samples of antenna output signals then analyzes those output signals to make linearity measurements and to compare measured linearity to a linearity target. The system may then adjust a power amplifier bias up or down in response to the comparison of the output signal samples and the linearity target. For instance, if analysis of the output signal samples indicates a high degree of linearity compared to a linearity target, then the system may decrease the power amplifier bias and then re-measure against the linearity target to maintain efficiency while not violating the linearity target. In some examples, the feedback loop may be coupled with a digital system that analyzes digital bits received by the feedback loop to compare observed linearity characteristics with the linearity target. In this manner, power amplifier bias may be adjusted during system operation to balance efficiency and linearity according to current operating conditions, thereby reducing margin and wasted power.

Furthermore, the system digitally generates values for modem chip gain, power amplifier bias, linearity, and output power in the feedback operation and may populate a table correlating modem chip gain, power amplifier bias, and output power for a multitude of output power levels. The system may then use the populated table in an open loop operation. Populating the table based on current operating conditions and using a digital feedback loop of the device itself may reduce or eliminate human effort that would otherwise be used to generate the tables manually.

According to one embodiment, a radio frequency (RF) system includes: a modem configured to generate a first set of digital bits as a reference signal and to create an analog RF signal from those digital bits; a power amplifier configured to receive the analog RF signal from a transceiver and further amplify the analog RF signal to a target power level; a feedback loop configured to couple output of the power amplifier, generate feedback sample capture, digitally process the reference signal and the feedback captured samples to determine a linearity characteristic of the power amplifier, and to adjust the biasing voltage in response to determining the linearity characteristic.

According to one embodiment, A radio frequency (RF) system includes: a modem configured to generate a first set of digital bits and to create an analog RF signal from those digital bits; a power amplifier configured to receive the analog RF signal and to amplify the analog RF signal, the power amplifier including an input for a biasing voltage; and a feedback loop configured to sample an output of the power amplifier, generate a second set of digital bits corresponding to the first set of digital bits, digitally process the second set of digital bits to determine a linearity characteristic of the power amplifier, and to adjust the biasing voltage in response to determining the linearity characteristic.

According to another embodiment, a method for performing average power tracking in a radio frequency (RF) system, the method includes: storing a set of initial values for RF device gain and output power level at a first bias value for a power amplifier; applying a first RF device gain value from the set of initial values in response to operating at a first output power level; sampling an output signal of the power amplifier and analyzing a down converted and digital representation of the output signal for a linearity characteristic; and adjusting a bias of the power amplifier to a second bias value in response to determining the linearity characteristic.

According to yet another embodiment, a radio frequency (RF) system including: means for storing a set of initial values for RF device gain an output power level at a first bias value for a power amplifier; means for generating a plurality of digital bits at a first RF device gain value from the set of initial values in response to operating at a first output power level; means for analyzing a down converted and digital representation of an output signal of the power amplifier to measure adjacent channel leakage ratio (ACLR) associated with the power amplifier; and means for adaptively adjusting a bias of the power amplifier to a second bias value in response to comparing measured ACLR with a target for ACLR.

According to another embodiment, a computer program product having a computer readable medium tangibly recording computer program logic for performing adaptive power tracking in a system having a modem and a power amplifier, the computer program logic including code which when executed by one or more processors causes the one or more processors to: receive a first command instructing operation at a first output power level; in response to the first command, applying a default power amplifier bias and a modem gain value in accordance with the first output power level; down converting and digitizing an output of the power amplifier; digitally measuring a linearity characteristic of the power amplifier after the down converting and digitizing; and adjusting a bias of the power amplifier down in response to measuring the linearity characteristic at a value below a linearity target.

### BRIEF DESCRIPTION OF THE DRAWINGS

FIG. 1 illustrates an example wireless device having adaptive power tracking, in accordance with an embodiment of the disclosure.

FIG. 2 illustrates an example wireless system having adaptive power tracking, in accordance with one embodiment of the disclosure.

FIG. 3 is an illustration of an example method of adaptive power tracking that may be used in the embodiments of FIGS. 1 and 2.

FIG. 4 is an illustration of an example method of adaptive power tracking that may be used in the embodiments of FIGS. 1 and 2.

FIG. 5 illustrates an example power amplifier that may be used in the systems of FIGS. 1 and 2, according to one embodiment of the disclosure.

### DESCRIPTION

Systems and methods for adaptive power tracking are provided herein. In one example, a system includes a wireless user device, such as a smart phone, tablet computer, or the like. The wireless device has a transceiver with a transmit path, a receive path, and a feedback loop in the transmit path. Focusing on the transmit path in this example, the transmit path may be at least partly included in a modem chip that outputs an RF analog signal to a power amplifier (PA). The modem chip itself applies an adjustable gain to the analog signal, and the PA also applies gain before passing the RF analog signal to an output device, such as an antenna.

Continuing with the example, the PA may be coupled to a supply voltage (VDD) that may be adjustable to bias the PA. The modem chip includes a table or other data structure correlating gain at the modem chip with the output power levels, and the table assumes a default value for PA regardless of output power level. At the beginning of operation (e.g., at power up or turn on of wireless data) the modem chip may access the table in response to operating at a particular output power level. The modem chip may set gain according to a value in the table that is associated with the particular output power level. During operation, the modem chip receives feedback from the transmit path so that it samples an output of the PA. The modem chip generates a set of digital bits from the output of the PA and digitally processes the set of bits to determine a linearity characteristic of the power amplifier. An example of a linearity characteristic includes adjacent channel leakage ratio (ACLR), and another example of a linear characteristic includes compression.

The modem chip may then adjust VDD to provide an appropriate biasing voltage to achieve a desired linearity behavior. For instance, in one example, the system has a target for ACLR. In general, a higher value for ACLR in dB means more leakage into adjacent channels and thus less linearity. The modem chip analyzes the digital bits to determine a value for ACLR and compares that value for ACLR to the ACLR target. If ACLR is below the ACLR target, then the system may reduce the biasing voltage to the PA, thereby increasing efficiency while at the same time maintaining an appropriate ACLR margin. On the other hand, if ACLR is above the ACLR target, then the system may increase the biasing voltage to the PA, sacrificing some efficiency to maintain the appropriate ACLR margin.

During normal operation, the device may transmit at a multitude of different output power levels, adjusting a bias voltage at each change of power level to maintain the linearity characteristic while reducing VDD. The device may further populate a table correlating modem chip gain values with output power levels and biasing voltages in response to the power level changes. Over time, the table may be fully populated and converged. Values of the table may then be reused at other appropriate times in an open loop operation.

Various embodiments may include methods as well. One example method may be performed by a processing unit, such as a modem chip, in an RF system. The processing unit in its transmit path generates a first set of digital bits, converts the digital bits to an analog signal, and mixes the analog signal to create an RF signal. The processing unit passes the RF signal to the PA, where the PA provides additional gain to the RF signal. The example method further includes sampling output signals at the PA, and generating a second set of digital bits corresponding to the first set of digital bits. The method correlates the first set of digital bits (transmission bits) with the second set of digital bits (feedback bits) to identify the second set of digital bits as they are received.

Continuing with the example, generating the second set of digital bits may include down converting the sampled signal and then performing analog-to-digital conversion on the down converted signal. The example method further includes digitally processing the second set of bits to determine a linearity characteristic of the PA, and adjusting a biasing voltage of the PA in response to determining a linearity characteristic.

Examples of adjusting the biasing voltage of the PA include sending control signals to a power supply (e.g., a low drop out power supply, a switched mode power supply, or other appropriate power supply) to either increase or decrease VDD.

In some examples, processing and analyzing the digital bits of the sampled signal may be performed by functionality in the processing unit. For instance, the processing unit may include non-transitory computer readable media having code which when executed provides the functionality to process the sampled signal, analyze the sampled signal for linearity characteristics, and to adjust the biasing voltage.

An advantage of some embodiments may be that much of the labor involved in generating open loop operating tables may be reduced by virtue of populating a table through adaptive operation. This may be in contrast to a manual operation that might otherwise be performed by human operators to correlate values of modem chip gain, VDD, and output power by manually testing a manufactured device with an external tester. Another advantage of some embodiments may be that the adaptive feedback loop operates digitally, taking advantage of advanced digital resources available in some more modern modem chips. Furthermore, using digital resources already available in a modem may reduce or eliminate the use of analog feedback hardware, such as analog power detectors.

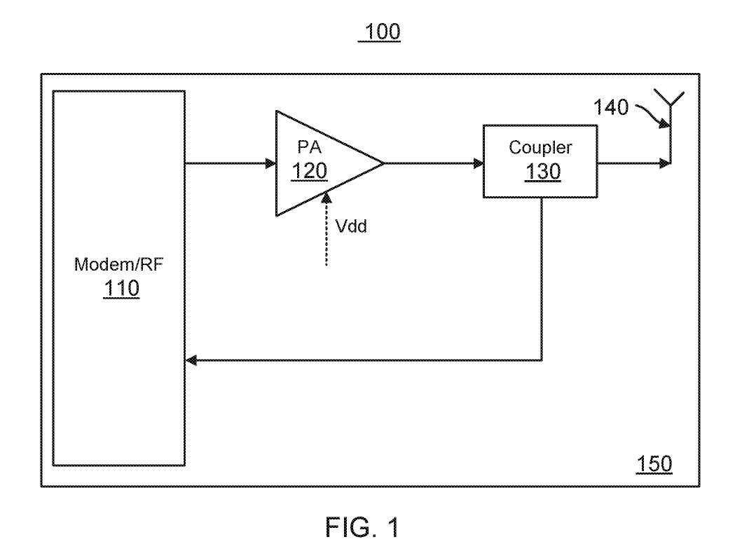

FIG. 1 shows an example RF system 100 for adaptive power tracking, according to one embodiment. The embodiment of FIG. 1 may be included in a tablet computer, a smart phone, or other wireless communication device that uses Long Term Evolution (LTE) or other wireless communication protocol. The system 100 has a feedback loop that samples a signal from the output of the PA 120 and provides that sample to the modem chip 110. The modem chip 110 analyzes the sample and applies an adaptive algorithm, as described in more detail below.

While this example refers to a modem chip 110, the scope of embodiments is not limited to a single modem on a single semiconductor chip, exclusive to other items. Rather, the modem chip 110 of this example embodiment may include a modem integrated on a semiconductor chip with or without other functional units. For instance, in one example, modem chip 110 may be implemented as a system on chip (SOC) that includes multiple functional units, such as a central processing unit (CPU), digital signal processor (DSP), graphics processing unit (GPU), and one or more modem cores, among other devices. However, other embodiments may include a modem itself, separate from other functional units, if appropriate. Furthermore, PA 120 may or may not be implemented on a same semiconductor chip with the modem.

Example RF system 100 in FIG. 1 further includes PA 120, coupler 130, antenna 140, and printed circuit board 150. Modem chip 110, power amplifier 120, coupler 130, and antenna 140 may be mounted to a printed circuit board 150, and printed circuit board 150 may be disposed within a housing (not shown) of a wireless communication device. FIG. 1 illustrates a transmit path and a feedback path, but omits a receive path for ease of illustration.

Continuing with the example of FIG. 1, the modem chip 110 receives a baseband signal, applies gain to the baseband signal, and converts the baseband signal to an RF signal. The modem chip 110 then sends the RF signal to the PA 120. In the present system, there may be a feedback loop from the output of the PA 120 to the modem chip 110, where the feedback loop samples the output signal. Specifically, in this example the coupler 130 provides a hardware point between the output of PA 120 and antenna 140 at which to sample the output signal.

The modem chip 110 receives the sample of the output signal and analyzes it to determine output power and ACLR. Functionality provided by software or firmware in the modem chip 110 may then correlate the output power, ACLR, and PA bias. If the ACLR is better than a threshold, then that may be an indication that the PA bias may be reduced. Accordingly, the modem chip 110 may reduce the PA bias and may analyze the transmit signal again to measure ACLR. The modem chip 110 does this iteratively until it finds a lowest bias value that provides an acceptable ACLR value at the given output power. If ACLR exceeds the threshold to become unacceptable (i.e., there may be an unacceptable amount of energy on adjacent channels), then the modem chip 110 may iteratively measure ACLR and raise the PA bias until ACLR crosses the threshold again into an acceptable range. Acceptable ACLR may be defined by a customer, by government regulations, or by or other entity in units such as dB.

The embodiment of FIG. 1 further populates a table to correlate modem chip gain, PA bias, and output power over time as it operates. For instance, as RF system 100 operates, it receives commands from a base station to use particular output power levels. In this example, when RF system 100 receives a command to operate at a particular power level, it consults a table correlating output power levels with modem chip gain values, applying an appropriate modem chip gain value for a given power level and applying a default VDD. It may then adjust VDD from the default value to a more efficient level, as described above. Each time RF system 100 changes to a different power level, it performs adaptive power tracking to settle on a bias voltage level for VDD that maintains an appropriate linearity margin. RF system 100 may then store that VDD value in a table that correlates the VDD value, the modem chip gain value, and the output power level. Over a period of time, the table becomes populated with a plurality of entries. Continuing with the example, RF system 100 may save the table to volatile or nonvolatile memory. Later, the RF system 100 parses the table for values in an open loop fashion to read out VDD levels and modem chip gain values in response to receiving commands to use particular output power levels.

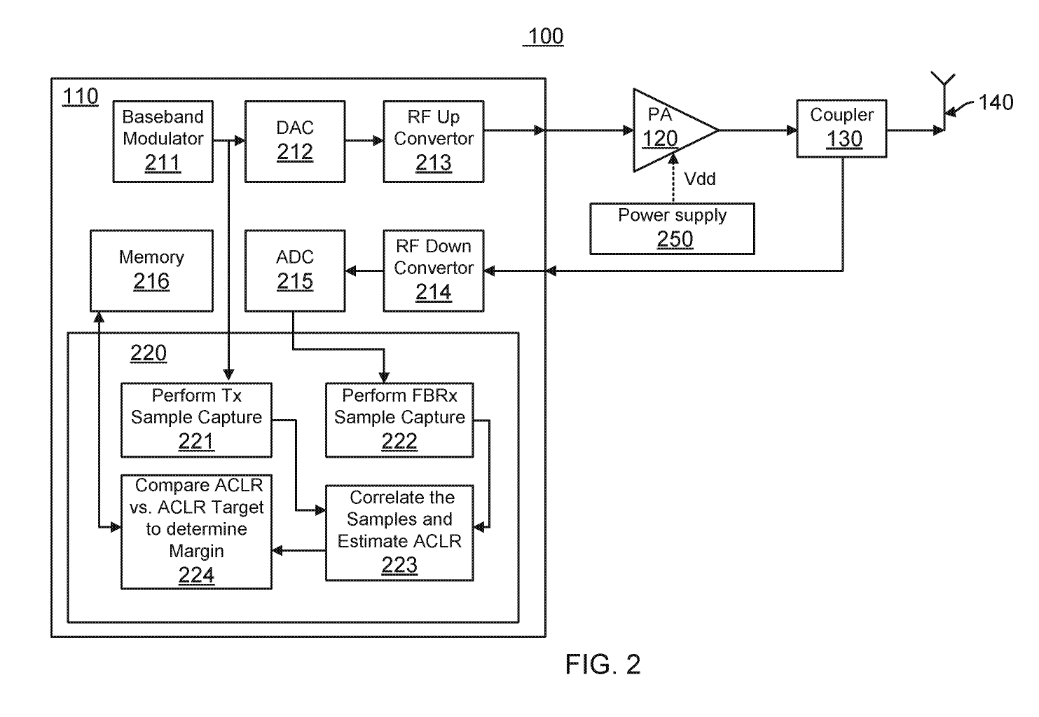

FIG. 2 is an example of RF system 100 of FIG. 1, providing more detail as to a possible architecture for RF system 100, according to one embodiment. FIG. 2 shows modem chip 110 including baseband demodulator 211, digital to analog converter (DAC) 212, and RF up converter 213 in its transmit path. The feedback path includes RF down converter 214 and analog-to-digital converter (ADC) 215.

Furthermore, digital processing portion 220 includes functional modules 221-224 to process the feedback, analyze the feedback for linearity characteristics, determine bias voltage adjustments, and instruct a voltage supply in accordance with any change for bias voltage adjustment. Digital processing portion 220 may be provided by modem chip 110 executing machine-readable code (e.g., DSP code) to provide the actions associated with functional units 221-224. Of note is that digital processing portion 220 in this example may be digital and may operate on bits generated from RF down converter 214 and ADC 215, as explained further below.

Baseband modulator 211 receives a baseband signal and produces a series of bits representing, e.g., voice data. DAC 212 produces an analog baseband signal from the output of modulator 211. RF up converter 213 mixes the analog baseband signal with a carrier wave to produce an RF signal. Modem chip 110 may apply gain to the RF signal at up converter 213. The transmit path further includes PA 120, which receives the RF signal and applies further gain. The output of PA 120 may be an amplified RF signal, which may be transmitted as an electromagnetic wave by antenna 140.

The feedback path samples the amplified RF signal at an appropriate point, such as at coupler 130, and passes that sampled signal to the RF down converter 214. The RF down converter 214 generates the baseband analog signal from the received RF signal, and ADC 215 generates digital bits therefrom.

Functional module 221 receives digital bits from the transmit path at the output of baseband modulator 211. Similarly, functional module 222 receives digital bits from the receive path at the output of ADC 215. The two sets of digital bits should in theory be the same, although there might be time delay attributable to hardware components of the transmit path and the feedback path (e.g., 10 microseconds or so). Accordingly, functional unit 223 correlates the transmit path bits with the feedback path bits to identify the feedback path bits. The correlation may be performed using an appropriate time domain or frequency domain correlation algorithm, now known or later developed.

Functional unit 223 also estimates ACLR for the feedback bits after those bits have been correlated. Estimating ACLR may include, for example, using a Fast Fourier Transform (FFT)-based power spectrum estimation, emission power integration by setting a band pass filter at measurement offset frequency, or other appropriate method to identify energy attributable to adjacent channels and to the desired channel. An example ACLR measurement may be done at a frequency offset following a standard definition, or may be done at a non-standard specified frequency offset, and the integrated emission power may be calculated over the particular frequency offset. ACLR is then, as its name indicates, a ratio of energy in adjacent channels versus energy in the desired channel.

Functional unit 224 compares the measured ACLR value from functional unit 223 to an ACLR target value. For instance, the ACLR target value may be a threshold value against which the measured ACLR value may be compared. When the measured ACLR value is below the target value, then the system may be operating with a linearity margin. Functional module 224 may receive the ACLR target value from memory 216 or from another memory (not shown).

Functional unit 224 further adjusts the biasing voltage for PA 120 in response to the comparison of measured ACLR value to ACLR target. For instance, if the measured ACLR value in dB is below the target value, then the functional unit 224 may then lower the biasing voltage by instructing power supply 250 to lower VDD by a certain amount (e.g., a pre-programmed incremental step in millivolts or other appropriate unit). RF system 100 then continues to operate, with the transmit path and the feedback path operating as described above. Digital processing portion 220 then analyzes the feedback bits again, compares measured ACLR against target ACLR, and then adjusts the biasing voltage as appropriate.

In some instances, the comparison of measured ACLR to the ACLR target may indicate that there is no linearity margin and that ACLR may exceed the threshold. In such an instance, functional unit 224 may then instruct the power supply 250 to raise VDD by certain amount and then re-analyze feedback, adjusting the biasing voltage if appropriate, to bring ACLR into an acceptable range.

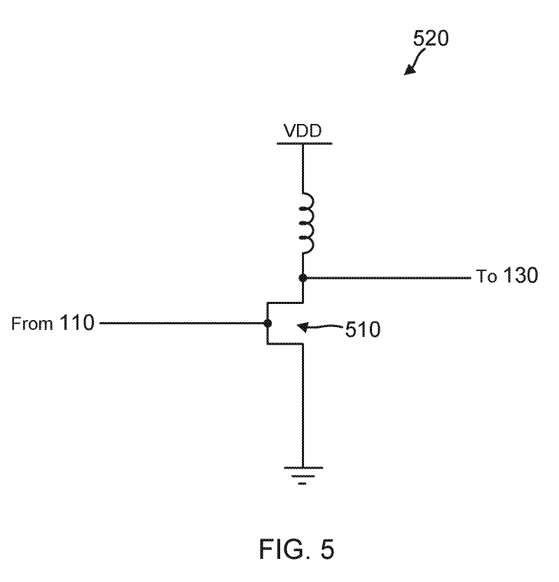

Continuing with the example above, PA 120 may be implemented in any appropriate manner FIG. 5 is an illustration of an example PA 520, which may be used as PA 120 in the example embodiments of FIGS. 1 and 2. PA 520 includes transistor 510, which may include a complementary metal oxide semiconductor field effect transistor (MOSFET), a bipolar junction transistor (BJT), GaAs heterojunction bipolar transistor (HBT) or other appropriate transistor.

The control terminal of transistor 510 receives the RF signal from modem chip 110. One of the other terminals of transistor 510 may be used as an output terminal. For instance, in an example wherein transistor 510 includes a MOSFET transistor, its gate may be used as a control terminal and its drain may be used as an output terminal, and the voltage level at the output terminal may be fed to coupler 130 and to antenna 140. The scope of embodiments includes any appropriate amplifier, including class A amplifiers, class B amplifiers, class C amplifiers, and others. The biasing voltage for PA 520 is shown as VDD, and it may be supplied by a power supply, such as power supply 250 of FIG. 2.

Returning to the example of FIG. 2, digital processing portion 220 may perform adaptive power tracking during normal operation, adaptively changing a bias voltage of PA 120 as output power and modem chip gain change. However, operation may begin with a characterization table (e.g., stored to memory 216) that is generated during a design process.

An example design process may begin by constructing a table that correlates gain at the modem chip 110 with different output power levels while holding the PA bias constant. This provides at least a few seed values. Gain at the modem chip may be represented in any appropriate manner. In the present example, gain at the modem chip is given by a gain index, which may include numerical values corresponding to discrete gain settings within the modem chip. In this example, such a table may be referred to as a characterization table, and one example characterization table is provided in Table 1:

TABLE 1

| Gain Index | Output power (dB) |
|---|---|
| 70 | 23 |
| 65 | 21 |
| 60 | 20 |
| 55 | 15 |

Although not shown in Table 1, it is understood that each of the values in the table may be associated with a default value for PA bias (e.g., 3.5 V). When the RF system 100 starts (e.g., at power up), it receives an indication that it should use a particular output power level. The modem chip 110 consults the seed table (Table 1) and then applies the corresponding modem chip gain from Table 1 and the default PA bias voltage. As the modem chip 110 operates it collects feedback information, analyzes the feedback information, and adjusts the PA bias as appropriate to achieve a linearity target, as described above. When the modem chip 110 achieves a desirable value for PA bias for the given output power and linearity target, it may populate a table with entries correlating gain at the modem chip with PA bias and with output power. An example table is shown below as Table 2, which correlates gain at the modem chip, PA bias, and output power.

TABLE 2

| Gain Index | VDD PA bias (V) | Output power |
|---|---|---|
| 70 | 3.45 | 22.8 |
| 69 | 3.43 | 22.1 |

As shown above, Table 2 has only two of its rows populated. However, it would be expected that over a period of time, with operation at various different output powers, that functional unit 224 would populate more and more rows of Table 2. In some examples, functional unit 224 may save Table 2 to memory 216, which may include volatile or nonvolatile memory. Furthermore, digital processing portion 220 may use Table 2 values in an open loop fashion, parsing Table 2 for appropriate values in response to commands to achieve a particular output power.

However, temperature variation may be a factor to consider in some applications, so various embodiments may build Table 2 every hour, at every power up, in response to thermal changes, or at other appropriate times in order to ensure that the system achieves appropriate operation at a current operating temperature. For instance, operation of a given device may vary with ambient temperature, providing different linearity behavior on a very hot day compared with a very cold day. Furthermore, heat produced by the CPU or GPU may affect linearity or efficiency of the PA as well. Accordingly, the system may be programmed to repopulate Table 2 as operating temperature changes to account for temperature variation. Furthermore, the system may perform calibration per-band, so that each time it changes to a different operating band it would begin the process by accessing seed values from Table 1 and then repopulating Table 2 or populating an additional table similar to Table 2. Also, the scope of embodiments is not limited to ACLR as a linearity metric, as other metrics, such as compression, may be used.

In this manner, the system adaptively achieves a balance between efficiency and linearity during operation and may store values for gain, PA bias, and output power so those values may be reused. Therefore, a benefit of some embodiments may be that adaptive power tracking may compensate for temperature variation of PA 120.

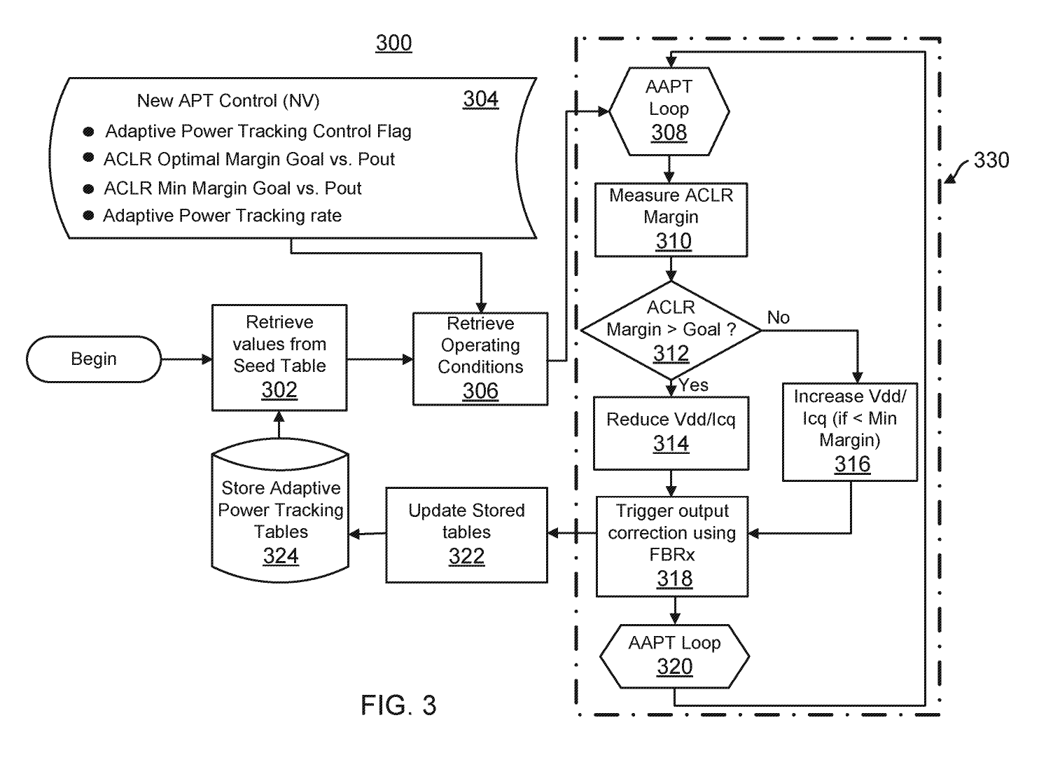

FIG. 3 illustrates a flowchart of an example method 300 of using the example system of FIGS. 1 and 2, according to one embodiment. Or put another way, method 300 performs adaptive power tracking using the feedback loop of FIGS. 1 and 2. In one example, method 300 may be performed by digital processing portion 220 of FIG. 2, or by another appropriate processing unit associated with RF system 100, by reading and executing computer-readable code to provide the functionality described herein.

For instance, the adaptive power tracking loop of the flow chart of FIG. 3 is noted as item 330. At action 302, digital processing portion 220 retrieves values from a seed table (e.g., Table 1) in response to a command to operate at a particular output power. At action 306, digital processing portion 220 also retrieves various operating conditions 304 relevant to adaptive power tracking, such as flags, minimum and maximum margin goals, and adaptive power tracking rate applicable to loop 330.

With the seed value and the other adaptive power tracking conditions, digital processing portion 220 then moves to adaptive power tracking loop 330. The adaptive power tracking loop 330 begins at action 308, which moves to action 310, wherein the digital processing portion 220 measures the ACLR margin. ACLR margin may include a positive difference (e.g., in dB) between target ACLR and measured ACLR. The greater the ACLR margin, the more potential there may be to reduce VDD while still being compliant with ACLR. A goal for ACLR margin may be set by a customer, a government, or other entity.

At action 312, digital processing portion 220 determines whether the ACLR margin is greater than a goal. Depending on the determination, the digital processing portion 220 may increase or reduce the bias (e.g., VDD at the PA) as described above with respect to FIGS. 1 and 2 at actions 314 and 316, respectively. Examples include measuring ACLR and increasing the bias if ACLR is within an unacceptable range or decreasing the bias if ACLR is within an acceptable range with some margin to spare. Increases or decreases may be performed in discrete steps and performed multiple times until, e.g., a lowest VDD bias is found that provides ACLR within the acceptable range. After a best-fit value of PA bias is found (perhaps after more than one iteration, as noted by actions 308 and 320) the digital processing portion 220 then operates at that particular PA bias at action 318. Subsequently, the system may then update a table, such as Table 2 above, to record the value for PA bias at actions 322-324. Operation over time may populate Table 2 with a multitude of entries corresponding to different output power levels. Digital processing portion 220 may repeat method 300 to repopulate or replace Table 2 as appropriate, such as in response to a change in thermal conditions, a change in operating band, or the like.

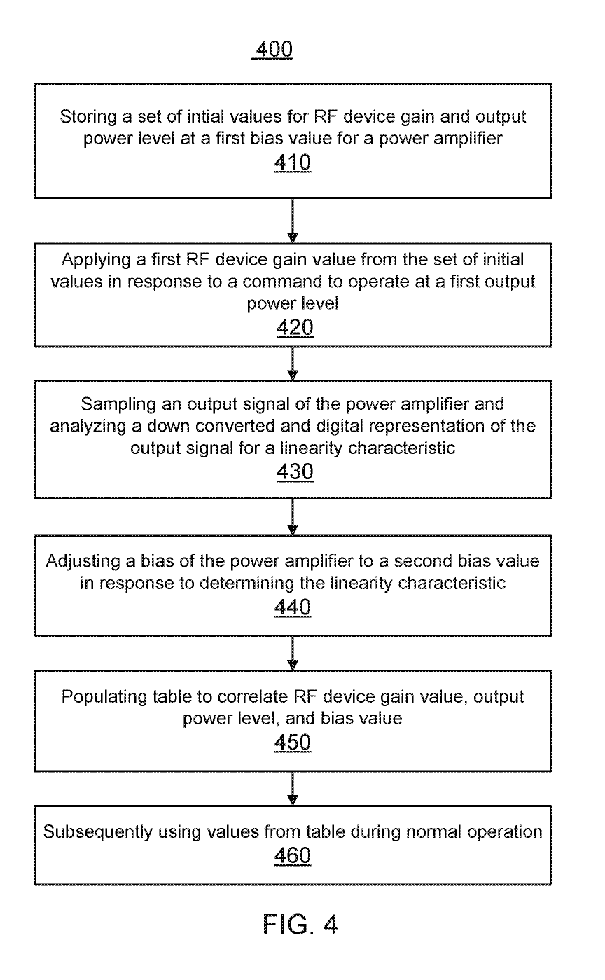

FIG. 4 is an illustration of another example method 400 which may be performed in the systems of FIGS. 1 and 2, according to one embodiment. In one example, method 400 may be performed by digital processing portion 220 of FIG. 2, or by another appropriate processing unit associated with RF system 100, by reading and executing computer-readable code to provide the functionality described herein.

At action 410, the system stores a set of initial values for the RF device gain and output power level at a first bias value for a PA. An example is shown above, at Table 1, wherein one column stores a set of values for modem chip gain, and each of those entries are associated with an entry for output power level. The set of initial values may be determined by testing and/or simulation and may use one default value for PA bias. The set of initial values may be stored, e.g., at memory 216 or other appropriate memory device.

At action 420, the RF system applies a first RF device gain value from the set of initial values in response to a command to operate at a first output power level. An example is described above, wherein the RF system 100 receives a command from a base station to operate at a particular output power level. Digital processing portion 220 parses a seed table for a modem chip gain value corresponding to the particular output power level. Digital processing portion 220 causes the RF device (e.g., a modem chip) to provide the gain value from the set of initial values.

At action 430, the digital processing portion samples an output signal of the power amplifier and analyzes a down converted and digital representation of the output signal for a linearity characteristic. In one example above, the linearity characteristic may be ACLR, and the digital processing portion performs an FFT or other appropriate transform to measure energy at adjacent channels and at the desired channel to determine ACLR.

In another example, the linearity characteristic includes compression of the PA. For instance, in some of its operating range, the PA may behave linearly by increasing an output power as a multiple of an input power increase. However, at higher powers, the approximately linear behavior may change to a log curve, wherein increases in input power result in less output power change than in the linear operating region. The log curve portion indicates compression of the PA, wherein compression is a characteristic that can be measured. In this alternative embodiment, the digital processing portion 220 of FIG. 2 may track changes in input power versus output power to determine an amount of compression of the PA at a given output power level.

At action 440, the digital processing portion adjusts a bias of the power amplifier to a second bias value in response to determining the linearity characteristic. For instance, if measured ACLR in dB is substantially below an ACLR target, then the digital processing portion 220 may cause a power supply to reduce VDD at the PA by an incremental amount. This may increase non-linearity, but within an acceptable range, while increasing efficiency through reduced VDD. On the other hand, if measured ACLR is above the ACLR target, then the digital processing portion may cause the power supply to increase VDD at the PA by an incremental amount. In any event, increases or decreases of VDD may be iterative, including adjustment, re-measurement and re-comparing, and further adjustment. In one example, action 440 may include adjusting VDD until it is at a lowest one of several discrete levels that provides linearity performance within an acceptable range.

Furthermore, in an embodiment wherein the linearity characteristic includes compression, action 440 may be similar in that if compression is below a target, the digital processing portion may cause the power supply to reduce VDD at the PA. Continuing with the example, if compression is above a target for compression, then the digital processing portion may cause the power supply to increase VDD of the PA.

At action 450, the digital processing portion 220 populates a table to correlate RF device gain value, output power level, and bias value. An example is shown at Table 2 (above), wherein the entries include modem chip gain, output power level, and VDD level achieved through adaptive power tracking for a variety of different output power levels. Action 450 may further include saving the table to volatile or nonvolatile memory, such as memory 216 of FIG. 2 or other appropriate memory.

At action 460, the digital processing portion 220 subsequently uses values from that table during normal operation. In one example, Table 2 may be at least partially populated with multiple different entries for multiple different output power levels and associated VDD levels achieved through adaptive power tracking. In one example the RF system is in open loop power tracking mode, and it may receive a command to operate at a particular output power level. In response that command, the RF system parses Table 2, selecting and applying a value for modem chip gain and a value for VDD associated with that particular output power level. The system may operate in open loop mode when it is determined, for instance, that Table 2 includes a particular number of entries, or at least an entry corresponding to a requested output power level. However, in the absence of an already-populated entry in Table 2, the digital processing portion may perform closed loop adaptive power tracking to determine a value for PA bias that provides an acceptable linearity margin and with an efficiency that may be greater than would be achieved using a default VDD level associated with a seed table.

The scope of embodiments is not limited to the particular actions shown in method 400. Rather, other embodiments may add, omit, rearrange, or modify one or more actions. For instance, actions 420-450 may be performed periodically or at other appropriate times to re-build Table 2. For instance, adaptive power tracking may be used to populate Table 2 at power up of the device or turn on of mobile data. Furthermore, adaptive power tracking may be used to populate Table 2 at a change of operating conditions, such as when thermal conditions at the PA are different due to operation of a CPU or GPU or due to ambient temperature changes.

In fact, adaptive power tracking may be used to compensate for temperature variation of the RF system at any appropriate time, including in response to operating condition changes. Actions 420-450 may be performed at a change of operating band to re-build Table 2 and may even include populating multiple tables, at least one table for each operating band in use. In fact, over time, the system may use method 400 to populate a variety of different tables for use with different operating bands and for use with different thermal conditions. Thus, open loop operation may include choosing a populated table it corresponds to a currently used operating band and current thermal conditions.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A radio frequency (RF) system comprising:
a modem configured to generate a first set of digital bits and to create an analog RF signal from those digital bits;
a power amplifier configured to receive the analog RF signal and to amplify the analog RF signal, the power amplifier including an input for a biasing voltage; and
a feedback loop configured to sample an output of the power amplifier, generate a second set of digital bits corresponding to the first set of digital bits, digitally process the second set of digital bits to determine a linearity characteristic of the power amplifier, and to adjust the biasing voltage in response to determining the linearity characteristic.

2. The RF system of claim 1, wherein the modem is configured to digitally process the second set of digital bits and to adjust the biasing voltage.

3. The RF system of claim 1, wherein the modem is implemented on a system on chip (SOC).

4. The RF system of claim 1, further comprising an antenna coupled to the output of the power amplifier, wherein the feedback loop is configured to sample the output of the power amplifier at a coupler to the antenna.

5. The RF system of claim 1, wherein the modem is configured to apply gain to the analog RF signal.

6. The RF system of claim 1, implemented in a transceiver of a wireless user device.

7. The RF system of claim 1, wherein the feedback loop comprises:
a RF down converter configured to sample the output of the power amplifier; and
an analog to digital converter (ADC) coupled with the RF down converter and configured to generate the second set of digital bits.

8. The RF system of claim 7, wherein the modem, the RF down converter, and the ADC are implemented in a semiconductor chip, further wherein the modem comprises computer-readable code, which when executed by the modem, determines the linearity characteristic of the power amplifier.

9. The RF system of claim 1, wherein the linearity characteristic comprises adjacent channel leakage ratio (ACLR).

10. A method for performing average power tracking in a radio frequency (RF) system, the method comprising:
storing a set of initial values for RF device gain and output power level at a first bias value for a power amplifier;
applying a first RF device gain value from the set of initial values in response to operating at a first output power level;
sampling an output signal of the power amplifier and analyzing a down converted and digital representation of the output signal for a linearity characteristic; and
adjusting a bias of the power amplifier to a second bias value in response to determining the linearity characteristic.

11. The method of claim 10, further comprising:
populating a table that correlates the first RF device gain value, the first output power level, and the second bias value.

12. The method of claim 10, further comprising:
subsequently applying a plurality of different values for RF device gain in response to operating at a plurality of different output power levels; and
populating a table that correlates the plurality of different values for RF device gain, the plurality of different output power levels, and a plurality of adjusted bias values.

13. The method of claim 12, further comprising:
parsing the table to identify a second RF device gain value and a third bias value corresponding to a received second output power level; and
operating an RF device at the second RF device gain value and operating the power amplifier at the third bias value corresponding to the received second output power level.

14. The method of claim 12, further comprising:
in response to a change of operating band, populating an additional table that correlates RF device gain, output power levels, and adjusted bias values at a currently used operating band.

15. The method of claim 10, wherein adjusting the bias of the power amplifier comprises:
comparing the linearity characteristic with a threshold for linearity; and
adjusting the bias of the power amplifier down in response to determining that the linearity characteristic is below the threshold for linearity.

16. The method of claim 10, wherein adjusting the bias of the power amplifier comprises:
comparing the linearity characteristic with a threshold for linearity; and
adjusting the bias of the power amplifier up in response to determining that the linearity characteristic is above the threshold for linearity.

17. The method of claim 10, further comprising:
transmitting the output signal by an antenna coupled to an output of the power amplifier.

18. The method of claim 10, wherein the RF system comprises a wireless user device.

19. A radio frequency (RF) system comprising:
means for storing a set of initial values for RF device gain an output power level at a first bias value for a power amplifier;
means for generating a plurality of digital bits at a first RF device gain value from the set of initial values in response to operating at a first output power level;
means for analyzing a down converted and digital representation of an output signal of the power amplifier to measure adjacent channel leakage ratio (ACLR) associated with the power amplifier; and
means for adaptively adjusting a bias of the power amplifier to a second bias value in response to comparing measured ACLR with a target for ACLR.

20. The RF system of claim 19, further comprising:
means for populating a table correlating a plurality of bias values for the power amplifier with a plurality of values for RF device gain and a plurality of output power levels in response to a plurality of operations adaptively adjusting the bias of the power amplifier.

21. The RF system of claim 19, wherein the means for analyzing a down converted and digital representation of the output signal comprises:
an RF down converter and a analog-to-digital converter (ADC) in a feedback loop from an output of the power amplifier.

22. The RF system of claim 19, wherein the generating means, the analyzing means, and the adaptively adjusting means are included within a modem chip in communication with the power amplifier.

23. The RF system of claim 22, wherein the RF device gain value comprises a gain value for the modem chip.

24. A computer program product having a computer readable medium tangibly recording computer program logic for performing adaptive power tracking in a system having a modem and a power amplifier, the computer program logic including code which when executed by one or more processors causes the one or more processors to:
receive a first command instructing operation at a first output power level;
in response to the first command, applying a default power amplifier bias and a modem gain value in accordance with the first output power level;
down converting and digitizing an output of the power amplifier;
digitally measuring a linearity characteristic of the power amplifier after the down converting and digitizing; and
adjusting a bias of the power amplifier down in response to measuring the linearity characteristic at a value below a linearity target.

25. The computer program product of claim 24, further comprising code which when executed by the one or more processors causes the one or more processors to:
receive a plurality of subsequent commands to operate at a plurality of different output power levels;
adjust the bias of the power amplifier in response to linearity measurements at respective ones of the different output power levels; and
populate a table correlating power amplifier bias values, modem gain values, and the plurality of different output power levels.

26. The computer program product of claim 25, further comprising code which when executed by the one or more processors causes the one or more processors to:
operate the modem in an open loop power tracking mode which selects power amplifier bias values in modem gain values from the table during normal operation.
